(19) United States
(12) Patent Application Publication
(10) Pub. No.: US 2007/0079552 A1
(43) Pub. Date: Apr. 12, 2007

(54) Easy-lift garden bag

(76) Inventor: Jianyi Sun, Duluth, GA (US)

Correspondence Address: FOISON PACKAGING, INC., 5060 NORTH ROYAL ATLANTA DRIVE, SUITE # 32, TUCKER, GA, 30084-3051, US

(21) Appl. No.: 11/247,309

(22) Filed: Oct. 11, 2005

(51) Int. Cl. A01G 9/02

(52) U.S. Cl. 47/65.8

(57) ABSTRACT

The Easy-Lift Garden bag appears as a soft vessel. This invention serves the purpose of replacing the hard plastic pot resembling vessel, which will environmentally change history of using hard plastic pots to grow flowers/trees/and plants. This product is waterproof, adhering to the correct process of growing flowers/trees/ and plants. By being well ventilated, and in the same instance allowing excess water to drain with keeping the suggested nurturing amount of moisture for the biology of the plant. Specifically I have designed two to four loops on the body of the Easy-Lift Garden bag, so it is convenient for non-manpower mechanism transportation. The finally conclusion the textiles of the Easy-Lift Garden bag is innocuous to the environment, and may be recycled. If we want to grow beautiful trees/plants/ and flowers, we as gardeners/biologists/nurserymen have to do our part to save the environment.

Growing large trees and plants is hard work, and not to mention a lengthy process. When shipping and purchasing plant/s, trees, and flowers they are typically in hard plastic gardening pots. These hard plastic pots are not only expensive, but they also are inconvenient to use.

First—For example, the cost of transportation is overrated, due to the bulky size of the hard plastic pots and kettles.

Second—The pots can be easily damaged and worse broken, which may cause injuries to the shippers/gardeners/nurserymen. Additionally other extra expenses consist of preparing them to be recycled, so they are in accordance of environmental protection.

Third—Elevating growing trees/plants/flowers while in the hard plastic pots directly, is humanly impossible. Preparation to utilize the proper machinery is ineffectual and once again time consuming.

Questioning these shortages, I successfully invented The Easy-Lift Garden Bag, which can easily solve all the problems listed above.

### BRIEF DESCRIPTION OF THE SEVERAL VIEWS OF THE DRAWINGS

FIG. 1A: Page 4/7:: Drawing 1/2

Element 1-1:: Body—The body of the Easy-Lift Garden bag, consists of environmentally safe PP & PE material (please refer to claims page 6/7).

Element 1-2:: Loops—Two to four loops are sewed on the openings edges, the amount of which are more or less based on the size of the Easy-Lift Garden bag (refer to claims page 6/7).

Element 1-3:: Drainage holes—In accordance with the life and nurturing of flowers and plants, I design drainage holes on the bottom portion of the Easy-Lift Garden bag for ventilation and drainage (please refer to claims page 6/7).

Element 1-4:: Stitching—Although there are only double stitches on the joint of body and bottom of the Easy-Lift Garden bag, the stitching enables the Easy-Lift Garden bag to stand freely in an oblong shape, once filled (please refer to claims page 7/7).

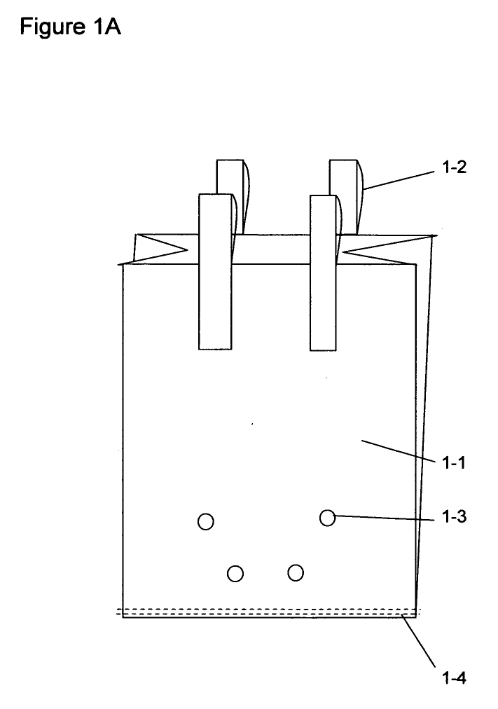

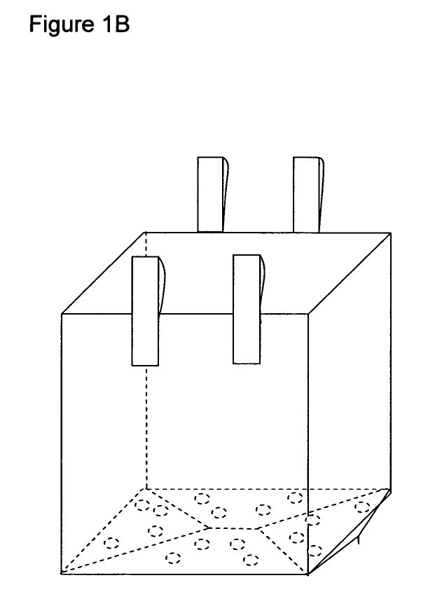

Inner viewing of stitching is visible on FIG. 1B Page 5/7 Drawing 2/2.

1. Body—The body of the Easy-Lift Garden bag, is made with environmentally safe PP & PE material.
Combined with the technique of weaving and coating, so that the texture of the textiles are soft, flexible, and waterproof. Supplementary treatment of ultraviolet resistant additives complete the fabric. The tensile strength of which will merely decrease 30%, being directly exposed to sunrays over a three year period.

2. Loops—Two to four loops are sewed on the openings edges, the amount of which are more or less based on the size of the Easy-Lifting Garden bag. Enabling accessibility of transportation by machinery (forklift) directly, with no use of manpower.

3. Drainage holes—In accordance with the life and nurturing of flowers and plants, I design drainage holes on the bottom portion of the Easy-Lifting Garden bag for ventilation and drainage. Simulating the current hard plastic pots feature, of drainage and ventilating the contents of the container. The diameter of the holes are less than 0.5″, to keep the soil from spilling excessively out from the bottom while drainage occurs.

4. Stitching—Precise stitching for strength is obtained by using gusset-shaped bag making technology. The planting density of the flowers/trees/ and plants enhances once the bag is filled.
Although there are only double stitches at the joining points of the bottom body of Easy-Lift Garden bag, the stitching enables the Easy-Lift Garden bag to stand freely in an oblong shape once filled.
